(19) United States
(12) Patent Application Publication
(10) Pub. No.: US 2009/0081622 A1
(43) Pub. Date: Mar. 26, 2009

(54) METHODS AND SYSTEMS TEACHING TONAL LANGUAGE

(76) Inventor: Harold David GOODMAN, Silver Spring, MD (US)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(21) Appl. No.: 11/861,254

(22) Filed: Sep. 25, 2007

(51) Int. Cl. G09B 19/00

(52) U.S. Cl. 434/156

(57) ABSTRACT

A method and system for teaching a tonal language in which the meaning of at least some words depends on the application of one of a plurality of tones. The method includes associating each of the plurality of tones with a hand position, expressing one of the at least some words and applying one of the tones to that word, and simultaneously with expressing the word, asserting a hand position associated with the applied one of the plurality of tones. Alternatively or in combination with the hand position, a color and/or a hand movement may be associated with a tone. The method may be embodied in a recorded medium such as CD or DVD.

### BACKGROUND OF THE INVENTION

1. Field of the Invention

The invention relates generally to methods and systems for teaching tonal languages. In particular, the invention is directed towards methods and systems for teaching tonal languages by activating and stimulating the auditory, visual, and kinesthetic portions of the brain to facilitate learning.

2. Description of Related Art

It is often useful for people to learn a non-native language, for either pleasure or business. In many instances, a person may have to travel to other countries with only short notice, and a working knowledge of the native language may be invaluable. Further, rapidly learning a new language may be required by a person's business. The non-native language may be fundamentally different from the native language spoken by the person, and the process of learning the non-native language may prove difficult and frustrating, and often may end in failure.

Known systems and methods for teaching languages may be effective for teaching languages to non-native speakers. Nevertheless, these known systems may require months of study, to which the student may be unwilling or unable to commit. Known systems also may require a significant amount of memorization, which many people may find difficult or frustrating. Known systems further often require significant amounts of study before a student becomes capable of understanding or communicating even the simplest of thoughts or expressions. These and other drawbacks may render conventional methods for teaching languages useless for students who, for various reasons, must rapidly gain a functional understanding of the language.

Specifically, known methods and systems for teaching languages may be ineffective for teaching languages with fundamentally different structures than the native language. Many known systems apply strict grammar translation methods for teaching languages, focusing on memorization of grammatical rules and sentence structures. Other known systems focus on situational language teaching, whereby students focus on memorizing and repeating common phrases in the non-native language. In these known systems, as the students progress to memorizing more complex phrases, the grammar and structure of the non-native language is learned indirectly. These systems may be inadequate for learning languages, especially languages which incorporate elements of tonality. Some common examples of tonal languages include all Chinese languages (Mandarin, Cantonese, Shanghai language, Hakka, Taiwanese, Hunan language, etc.), Lao, Thai, Vietnamese, Burmese, Tibetan and some African, European and South American indigenous tongues. Tonal languages are not to be confused with pitch accent languages.

Known methods and systems may be especially inadequate for teaching languages such as Mandarin Chinese, whereby meaning is imparted by applying a tone to each word, for which there is no English equivalent. For example, the same word in Chinese may have multiple different and independent meanings, depending on the tone applied to the word or syllable at the time it is spoken. Learning such tones and how to use them is difficult and may be the most challenging aspect of learning a tonal language. Known methods and systems for teaching Chinese and other tonal languages often do not fully explain or emphasize these tones, which may be fundamental in understanding the spoken language. In some methods and systems, the tones are merely listed as part of the “vocabulary” of the language, without showing the underlying concept behind the tones, thus requiring that the student learn four times as many vocabulary words.

### SUMMARY OF THE INVENTION

Therefore, there is a need for a method and system for teaching languages, including tonal languages, that is both quick and efficient. There also is a need for a method and system of teaching languages that seeks to employ sensory fusion to associate vocabulary and language elements with auditory, visual, and kinesthetic learning techniques, particularly to teach tones which may be an especially challenging aspect of learning the language.

In an embodiment of the invention, a method of teaching a tonal language in which the meaning of at least some words depends on the application of one of a plurality of tones may comprise associating each of the plurality of tones with a hand position, expressing one of the at least some words and applying one of the plurality of tones thereto, and simultaneously with expressing the one of at least some words, asserting the hand position associated with the applied one of the plurality of tones.

In another embodiment of the invention, a method of teaching a tonal language in which the meaning of at least some words depends on the application of one of a plurality of tones may comprise associating each of the plurality of tones with a color, expressing one of the at least some words and applying one of the plurality of tones thereto, and simultaneously with expressing one of the at least some words, visualizing the color associated with the applied one of the plurality of tones. The color may be combined with hand position, thereby associating the tone with both a color and a hand position.

In yet another embodiment of the invention, a method of teaching a tonal language in which the meaning of at least some words depends on the application of one of a plurality of tones may comprise associating each of the plurality of tones with a movement, expressing one of the at least some words and applying one of the plurality of tones thereto, and simultaneously with expressing one of the at least some words, articulating the movement associated with the applied one of the plurality of tones. The movement preferably is a hand movement and may be combined with hand position, thereby associating the tone with both a hand movement and a hand position. Further, the hand position and hand movement may be combined with a color so that the tone is associated with position, movement and color.

Other objects, features, and advantages will be apparent to persons of ordinary skill in the art from the following detailed description of the invention and the accompanying drawings.

### BRIEF DESCRIPTION OF THE DRAWINGS

FIG. 1 is a flowchart describing a method of teaching a tonal language according to an embodiment of the present invention.

FIG. 2 is a flowchart describing a method of teaching a specific tone associated with a language, according to an embodiment of the present invention.

FIG. 3 is a diagram showing hand positions associated with tones in accordance with a preferred embodiment of the present invention.

### DETAILED DESCRIPTION OF PREFERRED EMBODIMENTS

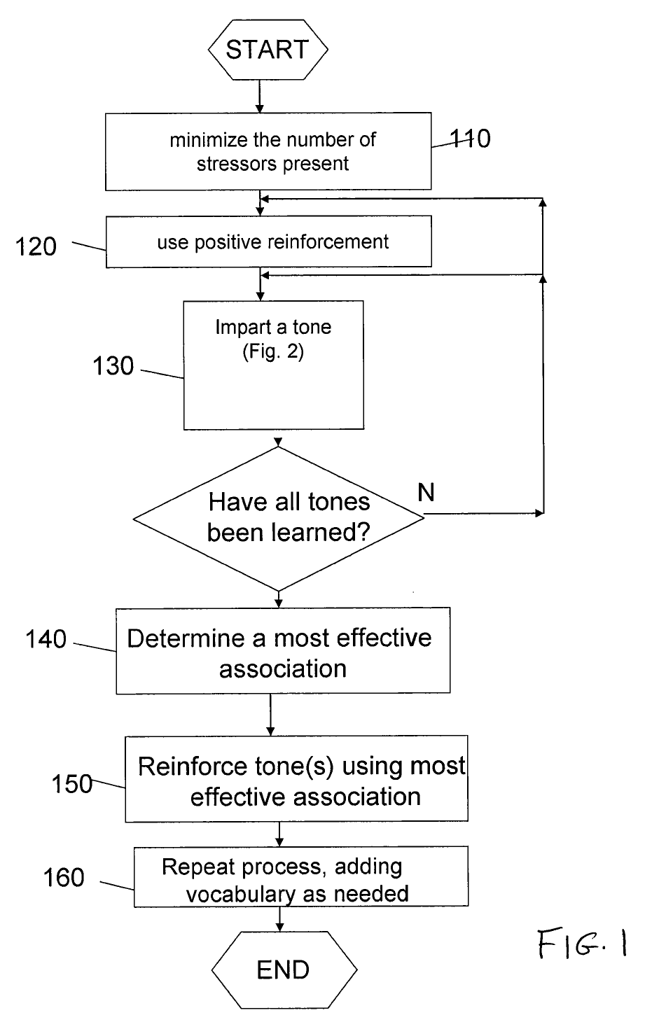

Preferred embodiments of the present invention and their advantages may be understood by referring to FIGS. 1, 2 and 3, like numerals being used for like corresponding parts in the various drawings.

Referring to FIG. 1, a method 100 for teaching tonal languages may include minimizing the number of stressors present 110. Stressors present may include harshness of light, sound, or presence of other people, stress due to work or other outside forces, or stress due to fear of failure to learn the desired language. Stressors may be removed through various techniques, including positive reinforcement, breathing exercises, and mental relaxation exercises. These techniques may be used whether the method is executed in person or by using a recordable medium. Other methods for reducing stressors may include the use of environmental relaxants, such as soothing colors, smells, and sounds. In an embodiment of the present invention uses a recordable medium, the method may include encouraging the user to find or create an environment which minimizes outside stressors.

After the number of stressors present has been minimized 110, positive reinforcement may be used 120 in order to facilitate learning of the tonal language. Positive reinforcement may include encouragement of the student, emphasis on the characteristics of the tonal language which may be simpler than the native language. For example, in one embodiment of the invention, Mandarin Chinese may be taught. In Mandarin Chinese, verbs do not have tenses, eliminating the need for complicated conjugations. In an embodiment of the invention, this fact may be highlighted multiple times in order to stress the ease with which the language may be learned.

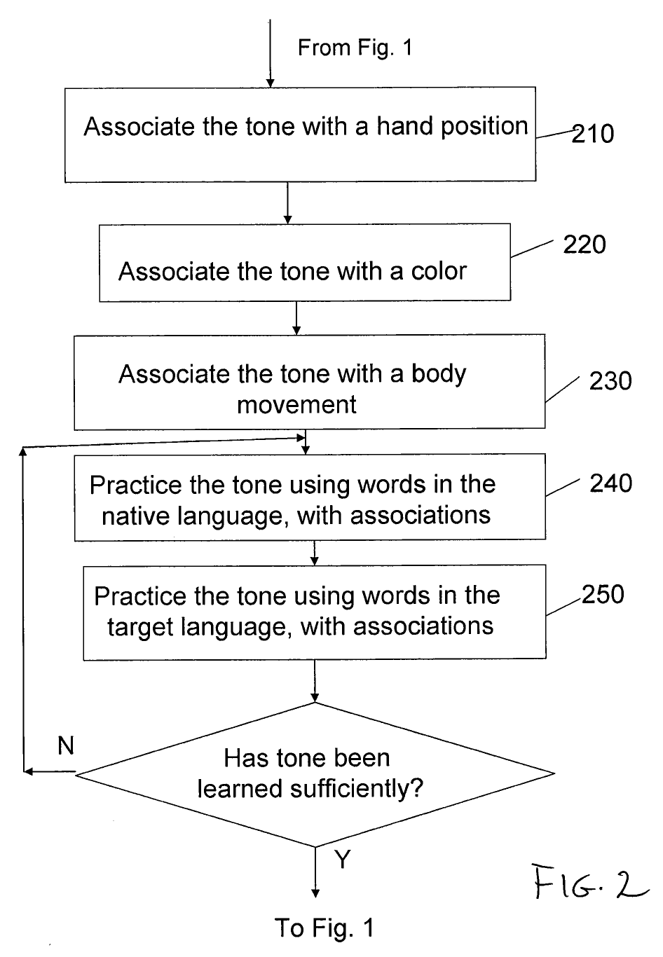

Once the number of stressors present are minimized 110, and positive reinforcement 120 is used, a tone may be imparted 130. This process of imparting tones and associating them with position, movement or color, or a combination thereof, is described in more detail in FIG. 2. After a tone is imparted 130, then the method determines if all of the tones associated with the tonal language have been imparted. If all the tones have not been imparted, then the method may include teaching another tone 130, until all the tones have been imparted. Optionally, after a tone is imparted, more positive reinforcement 120 may be used prior to the imparting of another tone 130.

After all tones have been learned or during the teaching of such tones, a determination may be made regarding the most effective association 140. In an embodiment of the invention, this determination may be made by a live instructor presenting the course, based on a student's feedback and their perceived response. This determination may be made subjectively, by interviewing the student to understand which association provides the most benefit, or the determination may be made objectively, by quizzing the student on their recollection using the various associations presented. In another embodiment of the present invention, when a live instruction is not present, e.g., when the student uses a recorded version of the method, then the student self-determines the most effective association. The tones may then be reinforced using the most effective association 150. The steps may then be repeated as necessary 160, adding vocabulary words and tones until the student reaches a sufficient level of proficiency in the language.

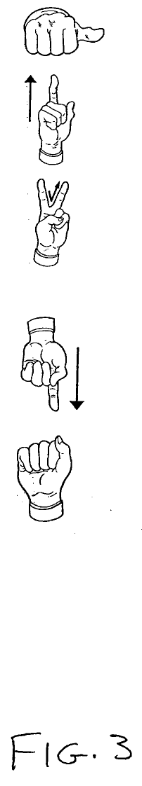

FIG. 2 describes the method of imparting a tone 200 according to an embodiment of the invention. The tone is associated with a hand position 210, e.g., the positioning of the thumb and/or fingers, the shape of the hand, or some combination thereof Preferred embodiments of these hand positions are illustrated in FIG. 3. The tone may also be associated with a color 220. Finally, the tone further may be associated with a body movement 230, such as a horizontal or vertical movement of the hand. The hand position may be related to a visual depiction of the tone, but there is no requirement that such a relation exist. Moreover, the tone preferably is taught in the student's native language using examples of words familiar to the student and imparting the tones to such words. For example, simple English language words such as “go” or “stop” or “halt” may be used to illustrate the sound of the tone, applied to familiar words, thus avoiding the need to learn the tone and a new vocabulary word at the same time.

It will be appreciated that the present method of learning tones thus is specifically designed to address all styles of learning. It permits the central nervous system to create pathways that reflect personal learning styles and to support the effortless recall and usage of the correct tone at the proper moment in the communication.

Once a tone is associated with a hand position, a color, and/or a movement, then the tone may be superimposed over words in the native language 240, and practiced. This association and practice serves to deepen the connection between the tone, and the associated hand position, color, and movement. The familiarity with words in the native language helps to focus the mind on the association between the tone and one or more of the hand position, color, or body movement, and not on the specific word. Once the tone has been practiced sufficiently in the native language 240, the tone may be applied to words in the target language 250. In this manner, vocabulary may be learned.

Depending on the application, as much or as little vocabulary as needed may be learned. Once all of the tones have been learned, each tone may be applied to as much or as little vocabulary as the application requires. For users needing a quick course in the language, e.g., for a business trip or the like, only a few vocabulary words and key phrases, may be learned. For users intending to spend extended time in a foreign country, or possessing a need to become fluent in a given language, then more vocabulary may be learned using this system.

A detailed explanation of the system using specific examples, according to an embodiment of the present invention, now follows. This explanation is merely for demonstrative purposes, in order to facilitate understanding of the invention. Although specific examples may be used herein, these should not be construed as limiting the invention to these examples.

In an embodiment of the present invention, the method may be adapted to teach Mandarin Chinese. Four tones are used in Mandarin Chinese. These tones may visually represented using accents, as follows: d\check{a}, dā, dá, and dà. In an embodiment of the present invention, the first tone is dā. This tone may be associated with the color “green.” In an embodiment of the invention, this color may be given a tangible object to associate with, such as “green thumb,” represented by a hand position with a closed fist and the thumb protruding sideways as shown in the uppermost diagram of FIG. 3. The tone dā may also be associated to a movement of moving the protruding thumb in a sideways motion. Thus, each time the tone dā is used, an association may be made to the color green. Likewise, each time the tone dā is used, an association may be made to the protruding thumb and movement of the thumb to the side. Although the color “green” and the body portion “thumb” may be related, this relationship is not necessary, and merely serves to reinforce the association. The tone dā may also be associated with a lateral movement of the hand, which motion may mimic the motion of the accent drawn when the dā is written. Thus, the tone dā may be associated with the color green, the body part “thumb,” and the sideways motion, individually or in combination. Each time the tone is spoken, the user may visualize a green thumb moving sideways, and may also move their own thumb in a sideways motion as the tone is pronounced. The long, even tone, may be associated with the lateral motion of the green thumb, thus “triggering” the auditory, visual, and kinesthetic portions of the memory, and implanting the tone and its associations into the user's memory.

In an embodiment of the present invention, the tone represented dá may be associated with the index finger, extended upward in the air, just as the visual representation of the tone dá features an accent that rises into the air as illustrated in the second diagram of FIG. 3. The tone may be associated, individually or in combination, with the upwardly pointing index finger and also may be associated with the color “blue,” and the motion of moving the extended index finger skyward, mimicking the motion of the accent on the dá tone. Similarly, in an embodiment of the present invention, the tone d\check{a} may be associated with one or more of the index and middle fingers extended upward in a “V” sign made with two fingers of the hand, as shown in the third diagram of FIG. 3, as well as the color “red,” and an up-and-down “V” motion made by the hand with the two extended fingers. As above, each time the tone is pronounced, the user may be encouraged to make a “V” shape with the hand, picture the color red, and picture the red “V” making an up-and-down motion. Finally, the tone represented dà may be associated with an index finger, pointed downward as illustrated in the fourth diagram of FIG. 3. The dà tone may also be associated with the color “black,” and the motion of stabbing downward, which may represent the motion of the accent of the dà tone, individually or in some combination. If desired, neutral or non-tonal words may be accompanied by a closed fist as shown in the fifth or bottom diagram of FIG. 3.

In an embodiment of the present invention, a teacher presents the method of teaching the tonal language to a single student or to a group of students. Because an extensive vocabulary may not be required, a teacher may not be required to have a high level of expertise in the language in order to successfully execute the method according to an embodiment of the present invention.

In another embodiment of the present invention, the method may be inscribed onto audio or visual recording media. Such media may include DVD-ROM, CD-ROM, audiotape, cassette tapes, digital tapes, or any other medium capable of storing and playing back audio and/or visual signals. In yet another embodiment of the present invention, the method may be carried out, recorded, and stored on a network, such as the Internet, for download and access anywhere.

While the invention has been described in connection with preferred embodiments, it will be understood by those skilled in the art that other variations and modifications of the preferred embodiments described above may be made without departing from the scope of the invention. For example, although the embodiments described herein make reference to specific colors, hand positions, and movements, the invention should not be considered to be limited to these embodiments. Other embodiments of the invention may incorporate different colors, hand positions, and movements not specifically enumerated herein yet within the scope of the appended claims. Thus, other embodiments will be apparent to those skilled in the art from a consideration of the specification or practice of the invention disclosed herein and set forth in the following claims.

What is claimed is:

1. A method of teaching a tonal language in which the meaning of at least some words depends on the application of one of a plurality of tones, the method comprising:
associating each of the plurality of tones with a hand position;
expressing one of the at least some words and applying one of the plurality of tones thereto; and
asserting the hand position associated with the applied one of the plurality of tones while expressing the one of at least some words.

2. The method of claim 1, further comprising the steps of:
associating each of the plurality of tones with a color; and
associating the color with the associated hand position.

3. The method of claim 1, further comprising the steps of:
associating each of the plurality of tones with a movement; and
associating the movement with the associated hand position.

4. The method of claim 1, wherein each of the plurality of tones is associated with a hand position selected from the group of: a closed fist with a thumb pointed sideways, a finger pointing upward, a finger pointing downward, and an index and a middle finger extended upward in a v-shape, wherein each hand position conveys information about the tone.

5. The method of claim 2, further comprising the steps of:
associating each of the plurality of tones with a movement; and
associating the movement with the associated hand position and the associated color.

6. The method of claim 4, further comprising the steps of:
determining a most effective association from the associated movement, the associated hand position, and the associated color;
repeating the expressing steps while emphasizing the most effective association.

7. The method of claim 1 including the step of minimizing stressors present in the teaching environment.

8. A method of teaching a tonal language in which the meaning of at least some words depends on the application of one of a plurality of tones, the method comprising:
associating each of the plurality of tones with a color;
expressing one of the at least some words and applying one of the plurality of tones thereto; and
simultaneously with expressing one of the at least some words, visualizing the color associated with the applied one of the plurality of tones.

9. The method of claim 8, wherein each of the plurality of tones is associated with a color selected from the group of: green, blue, black, and red.

10. The method of claim 8, further comprising the steps of:
associating each of the plurality of tones with a hand position; and
associating the hand position with the associated color.

11. A method of teaching a tonal language in which the meaning of at least some words depends on the application of one of a plurality of tones, the method comprising:
associating each of the plurality of tones with a movement;
expressing one of the at least some words and applying one of the plurality of tones thereto; and
simultaneously with expressing one of the at least some words, articulating the movement associated with the applied one of the plurality of tones.

12. The method of claim 11, wherein each of the plurality of tones is associated with a movement selected from the group of moving a hand with a protruding thumb in a sideways motion, moving a hand in a v-shape upward and downward, moving a hand with a pointed finger upward, and moving a hand with a pointed finger downward.

13. A system for teaching a tonal language comprising:
a recordable medium configured to record an execution of the method of claim 1;
a playback apparatus for converting information recorded on the recordable medium into at least auditory information.

14. The system of claim 13, wherein the recordable medium is a CD-ROM, a DVD-ROM, a cassette, video, or digital tape, or any other recordable medium.

15. The system of claim 13, wherein the recordable medium is made available on a network.

16. The system of claim 13, wherein the network is the Internet.
